(19) United States
(12) Patent Application Publication
(10) Pub. No.: US 2016/0344244 A1
(43) Pub. Date: Nov. 24, 2016

(54) Single Phase Brushless Motor And Electric Apparatus

(71) Applicant: Johnson Electric S.A., Murten (CH)

(72) Inventors: Yue Li, Hong Kong (CN); Chui You Zhou, Shenzhen (CN); Gang Li, Shenzhen (CN); Yong Wang, Shenzhen (CN); Yong Li, Shenzhen (CN); Wei Zhang, Shenzhen (CN); Ming Chen, Shenzhen (CN); Jie Chai, Shenzhen (CN); Tao Zhang, Shenzhen (CN); Jun Jie Chu, Hong Kong (CN); Xiao Bing Zuo, Shenzhen (CN)

(21) Appl. No.: 15/160,494

(22) Filed: May 20, 2016

(30) Foreign Application Priority Data
May 21, 2015 (CN) 201510262232.9
Apr. 8, 2016 (CN) 201610217337.7

(51) Int. Cl. H02K 1/14; E05F 15/697; H02K 11/33; H02K 1/27; H02K 7/14

(52) U.S. Cl. CPC H02K 1/14; H02K 1/276; H02K 7/14; H02K 11/33; E05F 15/697

(57) ABSTRACT

A single phase brushless motor and an electric apparatus are provided. The motor includes a stator and a rotor. The stator includes a stator core and windings. The stator core includes a yoke and at least two teeth. The tooth includes a tooth body and a tooth tip. The tooth tip includes first and second pole shoes. The rotor is received in a space defined between the first pole shoes and the second pole shoes. Each tooth forms a positioning groove facing the rotor between the first pole shoe and the second pole shoe. The first and second pole shoes are symmetrical about a central line of the tooth body and the positioning groove deviates toward the first pole shoe, such that the rotor startup capability in one direction is greater than the rotor startup capability in an opposite direction. The single phase motor has a larger startup torque with enhanced startup capability.

### CROSS REFERENCE TO RELATED APPLICATIONS

This non-provisional patent application claims priority under 35 U.S.C. §119(a) from Patent Application No. 201510262232.9 filed in The People's Republic of China on 21 May, 2015, and Patent Application No. 201610217337.7 filed in The People's Republic of China on 8 Apr., 2016.

### FIELD OF THE INVENTION

This invention relates to motors, and in particular to a single phase brushless motor and an electric apparatus employing the single phase brushless motor.

### BACKGROUND OF THE INVENTION

Single phase motors have the advantage of low cost. However, because of its poor startup capability, the use of the single phase motor in applications requiring high startup torque, such as in power tools, has been restricted. Therefore, a single phase brushless motor with strong startup capability is urgently desired.

### SUMMARY OF THE INVENTION

Thus, there is a desire for a single phase brushless motor which can overcome the above shortcomings.

In one aspect, a single phase brushless motor is provided which includes a stator and a rotor rotatable relative to the stator. The stator includes a stator core and windings wound around the stator core. The stator core includes a yoke and at least two teeth extending inward from the yoke. The tooth includes a tooth body and a tooth tip disposed at distal end of the tooth body. The tooth tip comprises a first pole shoe and a second pole shoe respectively located at opposite circumferential sides thereof, inner circumferential surfaces of the first pole shoes and the second pole shoes of the at least two teeth cooperatively defining a space therebetween. The rotor is received in the space. The tooth tip of each tooth forms a positioning groove facing the rotor, and the second pole shoe is greater than the first pole shoe such that the rotor startup capability in one direction is greater than the rotor startup capability in an opposite direction.

Preferably, a center of the positioning groove deviates from a central line of the tooth body of the tooth in a direction toward the first pole shoe, the first and second pole shoes each has a pole face facing the rotor, and the pole face of the second pole shoe is greater than the pole face of the first pole shoe.

Preferably, the rotor comprises a plurality of permanent magnetic poles arranged along a circumferential direction of the rotor, an outer circumferential surface of the rotor is not located on a same cylindrical surface, such that the inner circumferential surfaces of the first pole shoes and the second pole shoes and the outer circumferential surface of the rotor form there between a gap with an uneven thickness.

Preferably, the rotor further comprises a rotor core, the permanent magnetic poles are formed by a plurality of permanent magnets embedded in the rotor core, and an outer radius of the rotor core gradually decreases from a circumferential center to two sides of each permanent magnetic pole.

Preferably, a ratio of a maximum thickness to a minimum thickness of the gap ranges between 2 to 4.

Preferably, the rotor comprises a plurality of permanent magnetic poles arranged along a circumferential direction of the rotor, and an outer radius of the rotor gradually decreases from a circumferential center toward two sides of the permanent magnetic pole.

Preferably, the rotor further comprises a rotor core, the permanent magnetic poles are formed by a plurality of permanent magnets embedded in the rotor core, and an outer radius of the rotor core gradually decreases from a circumferential center to two sides of each permanent magnetic pole.

Preferably, the motor further comprises a controller connected with the stator windings, the controller is configured to invert a direction of a current flowing through the stator windings to change a startup direction of the rotor, and the startup capability of the rotor in one direction is greater than the startup capability of the rotor in an opposite direction.

Preferably, in the at least two teeth, the first pole shoe of a first tooth and the second pole shoe of a second tooth are located adjacent each other and are spaced apart by a slot opening, and the slot opening is overall located on a side of a middle line between the first tooth and the second tooth that is adjacent the first tooth.

Preferably, a width of the slot opening is greater than 2 mm.

Preferably, in the at least two teeth, the first pole shoe of a first tooth and the second pole shoe of a second tooth are located adjacent each other and are spaced apart by a slot opening, and a width of the positioning groove is once to twice of a width of the slot opening.

Preferably, a width of the slot opening is greater than 2 mm.

Preferably, a center position of the positioning groove deviates from a central line of the tooth body of the tooth by 10 to 15 degrees.

Preferably, a width of the positioning groove is equal to or greater than a width of the tooth body of the tooth.

Preferably, a distance from the inner circumferential surfaces of the first pole shoe and/or the second pole shoe to a center of the rotor gradually increases in a direction approaching the central line of the tooth body.

In another aspect, an electric apparatus such as a power tool is provided which utilizes the single phase brushless motor as described above.

The single phase motor of the above embodiments of the present invention has the following advantages: the cogging torque of the motor is increased by increasing the asymmetry of the stator teeth and the gap, which reduces the stop positions of the motor when not energized. By deviating the zero point of the failing edge of the cogging torque away from the zero-crossing point of the electromagnetic torque and by making the zero point of the rising edge of the cogging torque as close to the maximal electromagnetic torque position as possible, the startup capability of the motor is enhanced. Because of the asymmetry, the startup capability of the rotor in one direction is greater than the startup capability of the rotor in the other direction, which makes the motor especially suitable for use in applications such as power tools.

### BRIEF DESCRIPTION OF THE DRAWINGS

FIG. 1 and FIG. 2 are simplified schematic views of a single phase brushless motor of the present invention.

FIG. 3 is a simplified view of the rotor of FIG. 1.

FIG. 4 is a graph showing the relationship between the cogging torque and electromagnetic torque of the motor of FIG. 1.

FIG. 5 illustrates a magnetic flux distribution of the motor rotor of FIG. 1 at a natural stop position.

FIG. 6 illustrates a magnetic flux distribution of the motor rotor of FIG. 1 around an unstable position.

### DETAILED DESCRIPTION OF THE PREFERRED EMBODIMENTS

Below, the present invention will be described further in conjunction with embodiments illustrated in the drawings.

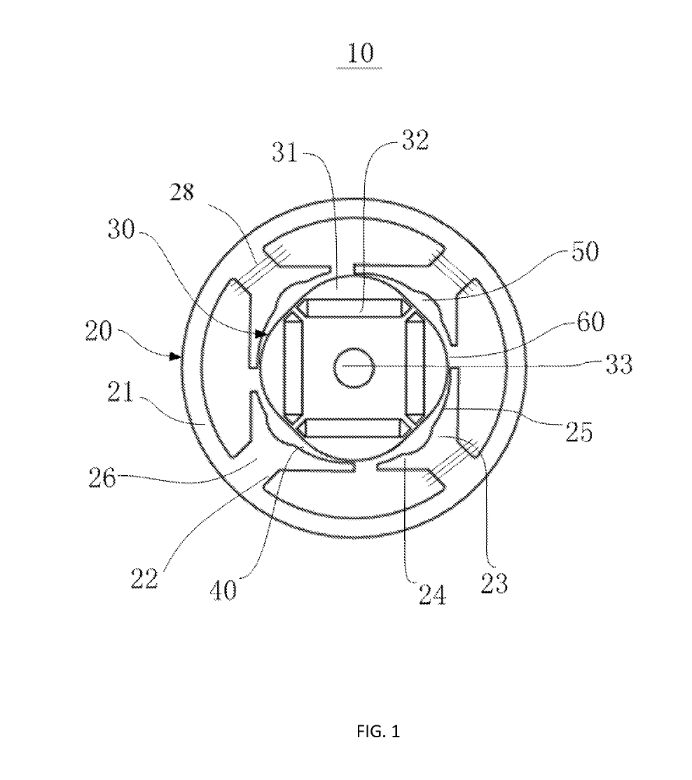

Referring to FIG. 1, a single phase brushless motor 10 in accordance with one embodiment of the present invention includes a stator 20 and a rotor 30 rotatable relative to the stator 20. The stator 20 includes a stator core made of a magnetic-conductive soft magnetic material such as silicon steel, and windings 28 wound around the stator core (only three windings are shown in the drawing). The stator core includes a yoke 21 and at least two teeth 22 extending inward from the yoke 21. The tooth 22 includes a tooth body 26 and a tooth tip 23 disposed at a distal end of the tooth body 26. The tooth tip 23 includes a first pole shoe 24 and a second pole shoe 25 extending toward two sides of the tooth, respectively. Each pole shoe 24, 25 has a pole face facing the rotor 30. A length of the pole face of the first pole shoe 24 is less than a length of the pole face of the second pole shoe 25. Preferably, inner circumferential surfaces of the first pole shoe 24 and the second pole shoe 25 are not located on a same circle.

In addition, the tooth tip 23 of each tooth 22 forms a positioning groove 50 facing the rotor 30 between the first pole shoe 24 and the second pole shoe 25.

In two adjacent teeth 22, the first pole shoe 24 of one tooth is located adjacent the second pole shoe 25 of the other tooth, and the first pole shoe 24 and the second pole shoe 25 are spaced by a slot opening 60, i.e. the tooth tips 23 of two adjacent teeth 22 are interrupted/separated by the slot opening 60.

As shown in FIG. 2, lengths of the first pole shoe 24 and the second pole shoe 25 are respectively indicated by L1 and L2, radial thicknesses of the first pole shoe 24 and the second pole shoe 25 are respectively indicated by W1 and W2, a width of the positioning groove 50 is indicated by a, and a width of the slot opening 60 is indicated by b. In this embodiment, L2>L1, and preferably, L2>=L1+b. That is, the slot opening 60 between adjacent two teeth 22 is overall located on one side of a middle line between the two teeth 22 that is adjacent the first pole shoe 24.

In this embodiment, the positioning groove 50 deviates toward the first pole shoe 24 of the tooth 22. In particular, a center position of the positioning groove 50 deviates from a central line of the tooth body 26 of the tooth 22 by an angle θ (the center O of the rotor 30 is the vertex of the central angle, one side of the angle θ is the central line 11 of the tooth body 26 of the tooth 22, and the other side is a line 12 passing through the center O of the rotor and a center point of the positioning groove 50) to further increase the asymmetry of the tooth 22. Preferably, the angle θ ranges between 10 to 15 degrees.

In this embodiment, the width a of the positioning groove 50 is substantially equal to a width of the tooth body 26 of the tooth 22. In an alternative embodiment, the width a of the positioning groove 50 may be less than or greater than the width of the tooth body 26 of the tooth 22.

In this embodiment, the width a of the positioning groove 50 is greater than the width b of the slot opening 60, but less than two times of the width b of the slot opening 60, i.e. b<a<2b. Preferably, the width b of the slot opening 60 is greater than 2 mm, more preferably greater than 2.5 mm. The slot opening 60 with a large size facilitates winding of the stator windings, and can increase the cogging torque of the motor as well, which can reduce the stop area of the motor when not energized, i.e. the range of stop positions where the cogging torque is less than a frictional torque.

In this embodiment, preferably, the radial thickness W1 of the first pole shoe 24 gradually decreases along a direction away from the tooth body, and the radial thickness W2 of the second pole shoe 25 gradually decreases along a direction away from the tooth body. That is, the first pole shoe 24 and the second pole shoe 25 have greater magnetic reluctance at a position closer to the slot opening 60.

Referring to FIG. 1 through FIG. 3, the rotor 30 is received in a space defined by the first pole shoes 24 and the second pole shoes 25 of the at least two teeth. The rotor 30 includes a plurality of permanent magnetic poles 32 arranged along a circumferential direction of the rotor 30. An outer circumferential surface of the rotor 30 is not located on a same cylindrical surface. Therefore, inner circumferential surfaces of the first pole shoe 24 and the second pole shoe 25 and the outer circumferential surface of the rotor 30 define there between a gap 40 with an uneven thickness. Preferably, a ratio of a maximum thickness to a minimum thickness of the gap 40 ranges between 2 to 4 times. This configuration facilitates increasing the cogging torque of the motor 10 and hence reducing the stop area of the motor when not energized.

In this embodiment, the rotor 30 further includes a rotor core 31. The rotor core 31 has a mounting hole 33 at a center thereof for fixedly mounting to a rotary shaft (not shown). The permanent magnetic poles 32 are formed by a plurality of permanent magnets 32 embedded in the rotor core 31, and the number of the permanent magnetic poles 32 is preferably equal to the number of the stator teeth 22. In this embodiment, the number of the permanent magnetic poles 32 and the number of the stator teeth 22 are both four.

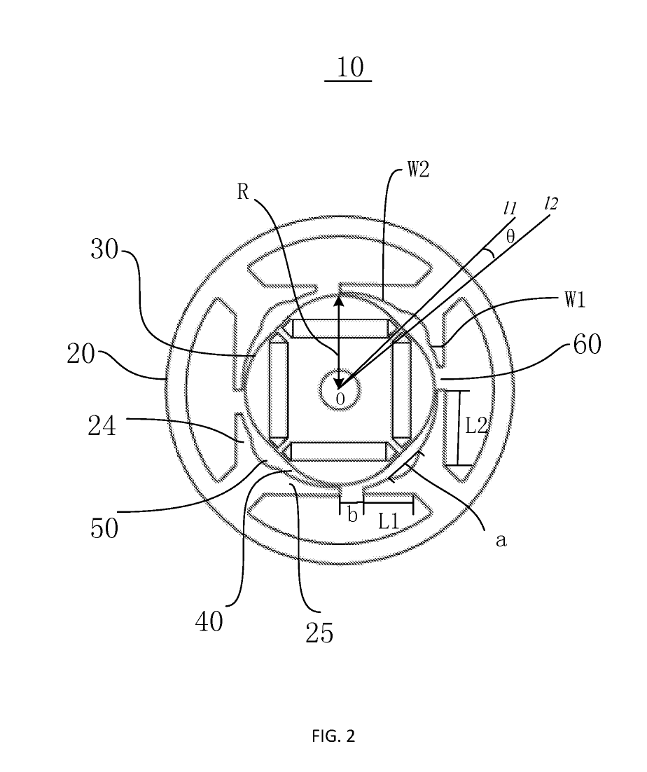

In this embodiment, as shown in FIG. 3, the outer circumferential surface of the rotor core 31 is a convex-concave arc-shaped structure which is not located on a same circle. In particular, an outer radius R (FIG. 2) of the rotor core 31 gradually decreases from a circumferential center toward two sides of the permanent magnetic pole 32. Preferably, the outer circumferential surface of the rotor core 31 is symmetrical about a rotor radius passing through the circumferential center of the permanent magnetic pole 32. A distance from the inner circumferential surfaces of the first pole shoe 24 and the second pole shoe 25 to the rotor center gradually increases in a direction approaching the central line of the tooth body. As such, the outer circumferential surface of the rotor core 31 and the inner circumferential surfaces of the first pole shoe 24 and second pole shoe 25 form there between a gap 40 with an uneven thickness. Therefore, when the rotor 30 stops, a part of the rotor core 31 with maximum outer radius (i.e. the circumferential center of the permanent magnetic pole 32) is more likely adjacent the first pole shoe 24 or the second pole shoe 25, which prevents the rotor 30 from stopping at the dead point position.

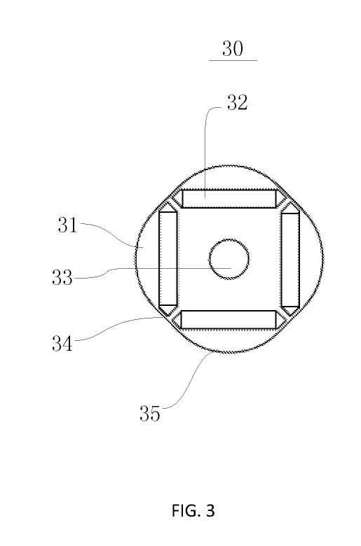

The advantage of the above configuration is that it can prevent the rotor 30 from stopping at the dead point position and increase the electromagnet torque during startup. In particular, as shown in FIG. 4, the upper graph of FIG. 4 shows the curve of the cogging torque of the motor during one electric cycle, with the horizontal ordinate representing time and the vertical ordinate representing the cogging torque. It should be understood that, during the course from rotating to stopping of the motor 10, the rotor 30 is likely to stop when the cogging torque is less than the frictional torque. The above configuration of the present invention increases the peak value of the cogging torque, such that the cogging torque at most positions of the rotor 30 is greater than the frictional torque, thereby reducing possible stop positions/areas of the motor when not energized and hence effectively preventing the rotor 30 from stopping at the dead point position.

The lower graph of FIG. 4 reflects the electromagnetic torque (which is based on Back-EMF, i.e. being directly proportional to the Back-EMF) of the motor 10 during one electric cycle, with the horizontal ordinate representing time and the vertical ordinate representing the electromagnetic torque. It should be understood that the rotor 30 can be started when the electromagnetic torque is greater than a sum of the cogging torque and the frictional torque.

An indication line L5 of FIG. 4 indicates a stop position of the rotor 30 where the cogging torque is zero. Preferably, the stop position is spaced from the zero-crossing point of the electromagnetic torque curve by an electric angle of more than 40 degrees. Preferably, at a startup phase, a ratio of an average output torque of the rotor starting in one direction to an average output torque of the rotor starting in another direction is greater than 11:9.

The rotor 30 very likely stops at a position where the cogging torque is equal to or close to zero, for example, the position indicated by the indication line L5 in FIG. 4. At this position/area, because the electromagnetic torque is far greater than zero, the stator windings of the motor 10 can produce a sufficient large startup torque upon being energized.

It should be understood that the rotor 30 of the present invention further has bidirectional startup capability, i.e. a direction of the current flowing through the windings 28 of the stator 20 during startup can be inverted by a motor controller (not shown) connected with the stator windings 28, such that the rotor 30 can be started in a desired direction. The rotation direction of the rotor 30 is controlled by controlling the direction of the current of the windings 28 of the stator 20. Due to the asymmetry of the tooth, the current flowing through the stator windings in different directions produces the electromagnetic torque with different values, i.e. the startup torque of the motor is different in different directions, with the startup torque in one direction greater than the startup torque in an opposite direction. This design is especially suitable for use in power tools or vehicle window lifter.

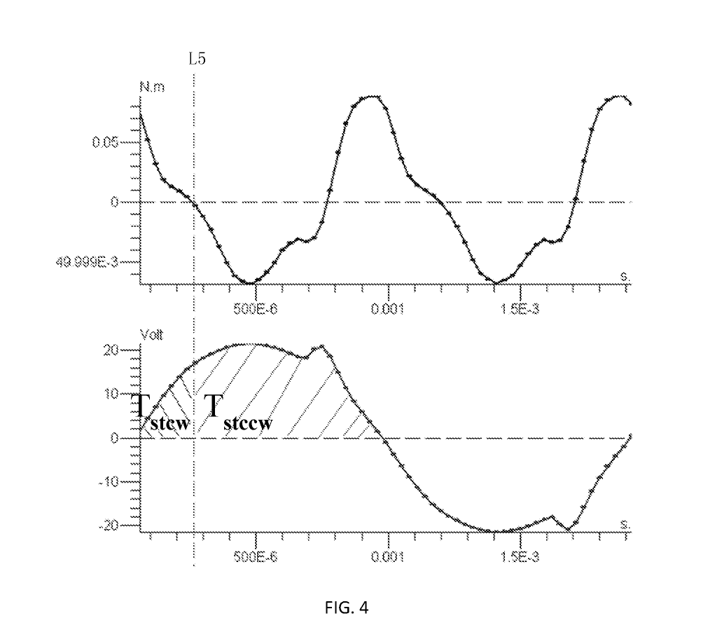

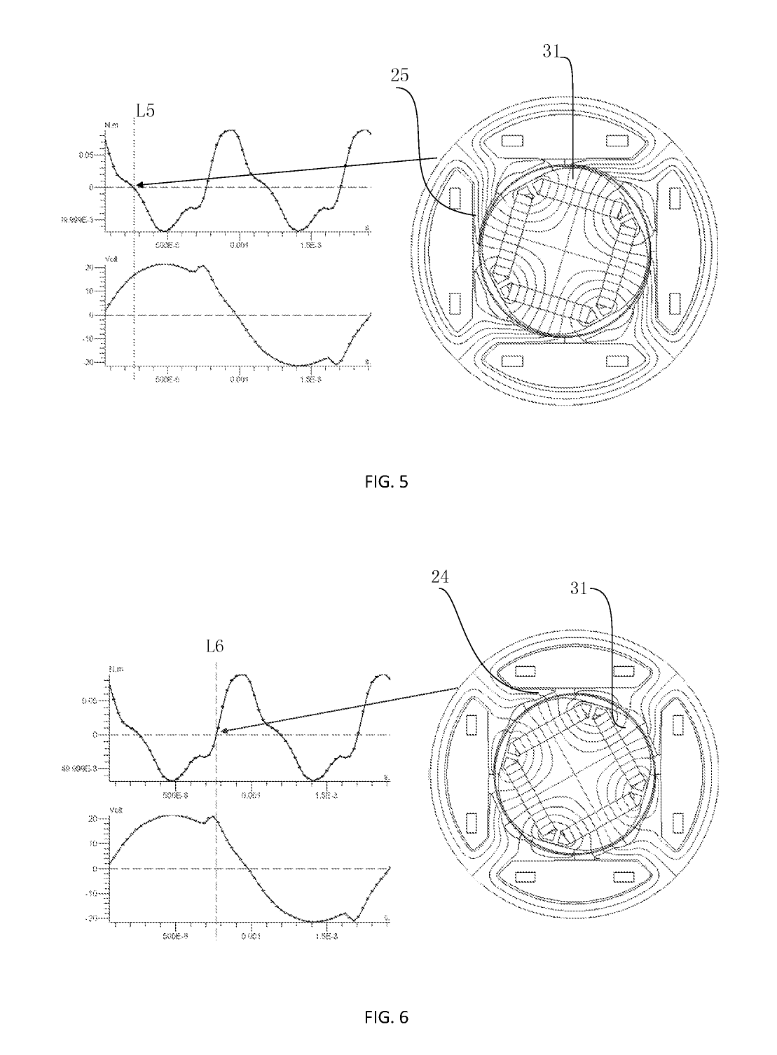

FIG. 5 and FIG. 6 illustrate two possible stop positions of the motor rotor 30, respectively. FIG. 5 illustrates a stop position of the rotor in a natural state (i.e. a state in which the frictional torque is very small), the maximal outer radius position of the rotor core 31 is adjacent the second pole shoe 25. The cogging torque and electromagnetic torque at this position may be determined with reference to the cogging torque curve and electromagnetic torque curve of the left graph of FIG. 5. In this figure, the indication line L5 indicates the stop position of the rotor 30.

FIG. 6 illustrates an unstable point of the rotor, i.e. a position where the rotor may stop if subject to a large frictional force. The maximal outer radius position of the rotor core 31 is adjacent the first pole shoe 24, and the cogging torque and electromagnetic torque at this position may be determined with reference to the cogging torque curve and electromagnetic torque curve of the left graph of FIG. 6. In this figure, an indication line L6 indicates the stop position of the rotor 30. As can be seen, the position of the rotor 30 illustrated in FIG. 6 is close to a position with maximal Back-EMF of the motor, which facilitates producing a large electromagnetic torque which is greater than the electromagnetic torque produced at the rotor position of FIG. 5.

In the above embodiments of the present invention, the yoke 21 of the stator core has a closed ring shape. In this case, the stator windings may be wound around the tooth bodies 26 of the teeth 22. It should be understood that the yoke 21 of the stator core may also have a closed frame shape, such as a rectangle shape, and in this case, the stator windings may be wound around the tooth bodies 26 of the teeth 22. The yoke 21 of the stator core may also have an opened frame shape, such as U- or C-shape. In this case, the stator windings may be wound around the tooth bodies 26 of the teeth 22 or the yoke 21. It should be understood that the stator core may be of an integral type or a split type. The yoke of the stator core and the teeth may be integrally formed or separately formed.

In the above embodiments of the present invention, the permanent magnets 32 are embedded in the rotor core 31. It should be understood that the permanent magnets 32 may also be mounted to the outer surface of the rotor core 31.

In the above embodiments, the stator tooth is of a salient type, i.e. the pole shoes extends circumferentially beyond two sides of the tooth body. It should be understood that the stator tooth may also be of a non-salient type, i.e. the pole shoes do not extend outward circumferentially beyond two sides of the tooth body, but rather are hidden at the distal end of the tooth body.

Although the invention is described with reference to one or more preferred embodiments, it should be appreciated by those skilled in the art that various modifications are possible. Therefore, the scope of the invention is to be determined by reference to the claims that follow.

1. A single phase brushless motor comprising:
a stator comprising a stator core and windings wound around the stator core, the stator core comprising a yoke and at least two teeth extending inward from the yoke, the tooth comprising a tooth body and a tooth tip disposed at distal end of the tooth body, the tooth tip comprising a first pole shoe and a second pole shoe respectively located at opposite circumferential sides thereof, inner circumferential surfaces of the first pole shoes and the second pole shoes of the at least two teeth cooperatively defining a space therebetween; and
a rotor rotatable relative to the stator, the rotor being received in the space;
wherein the tooth tip of each tooth forms a positioning groove facing the rotor, and the second pole shoe is greater than the first pole shoe such that the rotor startup capability in one direction is greater than the rotor startup capability in an opposite direction.

2. The single phase brushless motor of claim 1, wherein a center of the positioning groove deviates from a central line of the tooth body of the tooth in a direction toward the first pole shoe, the first and second pole shoes each has a pole face facing the rotor, and the pole face of the second pole shoe is greater than the pole face of the first pole shoe.

3. The single phase brushless motor of claim 1, wherein the rotor comprises a plurality of permanent magnetic poles arranged along a circumferential direction of the rotor, an outer circumferential surface of the rotor is not located on a same cylindrical surface, such that the inner circumferential surfaces of the first pole shoes and the second pole shoes and the outer circumferential surface of the rotor form there between a gap with an uneven thickness.

4. The single phase brushless motor of claim 3, wherein the rotor further comprises a rotor core, the permanent magnetic poles are formed by a plurality of permanent magnets embedded in the rotor core, and an outer radius of the rotor core gradually decreases from a circumferential center to two sides of each permanent magnetic pole.

5. The single phase brushless motor of claim 3, wherein a ratio of a maximum thickness to a minimum thickness of the gap ranges between 2 to 4.

6. The single phase brushless motor of claim 1, wherein the rotor comprises a plurality of permanent magnetic poles arranged along a circumferential direction of the rotor, and an outer radius of the rotor gradually decreases from a circumferential center toward two sides of the permanent magnetic pole.

7. The single phase brushless motor of claim 6, wherein the rotor further comprises a rotor core, the permanent magnetic poles are formed by a plurality of permanent magnets embedded in the rotor core, and an outer radius of the rotor core gradually decreases from a circumferential center to two sides of each permanent magnetic pole.

8. The single phase brushless motor of claim 1, wherein the motor further comprises a controller connected with the stator windings, the controller is configured to invert a direction of a current flowing through the stator windings to change a startup direction of the rotor, and the startup capability of the rotor in one direction is greater than the startup capability of the rotor in an opposite direction.

9. The single phase brushless motor of claim 1, wherein in the at least two teeth, the first pole shoe of a first tooth and the second pole shoe of a second tooth are located adjacent each other and are spaced apart by a slot opening, and the slot opening is overall located on a side of a middle line between the first tooth and the second tooth that is adjacent the first tooth.

10. The single phase brushless motor of claim 9, wherein a width of the slot opening is greater than 2 mm.

11. The single phase brushless motor of claim 1, wherein in the at least two teeth, the first pole shoe of a first tooth and the second pole shoe of a second tooth are located adjacent each other and are spaced apart by a slot opening, and a width of the positioning groove is once to twice of a width of the slot opening.

12. The single phase brushless motor of claim 8, wherein a width of the slot opening is greater than 2 mm.

13. The single phase brushless motor of claim 1, wherein a center position of the positioning groove deviates from a central line of the tooth body of the tooth by 10 to 15 degrees.

14. The single phase brushless motor of claim 1, wherein a width of the positioning groove is equal to or greater than a width of the tooth body of the tooth.

15. The single phase brushless motor of claim 1, wherein a distance from the inner circumferential surfaces of the first pole shoe and/or the second pole shoe to a center of the rotor gradually increases in a direction approaching the central line of the tooth body.

16. The single phase brushless motor of claim 1, wherein a yoke of the stator core has a closed ring shape, closed frame shape, or opened frame shape.

17. An electric apparatus comprising a single phase brushless motor of claim 1.

18. The electric apparatus of claim 17 being a power tool or a vehicle window lifter.
